(19) United States
(12) Patent Application Publication
(10) Pub. No.: US 2021/0227389 A1
(43) Pub. Date: Jul. 22, 2021

(54) MULTIPLE DEVICE ACCESS CONFIGURATION AND ALERTING

(71) Applicant: Avaya Management LP, Santa Clara, CA (US)

(72) Inventors: Christopher D. Baldwin, Princeton, NJ (US); Tibor Lukac, Superior, CO (US); Kurt Haserodt, Westminster, CO (US)

(21) Appl. No.: 16/745,843

(22) Filed: Jan. 17, 2020

(51) Int. Cl. H04W 12/08; H04W 12/06; H04L 29/06; H04L 29/12; H04M 7/00; H04M 11/04

(52) U.S. Cl. CPC H04W 12/08; H04W 12/06; H04L 63/0876; H04M 2203/551; H04M 7/0036; H04M 11/04; H04L 61/605

(57) ABSTRACT

The present disclosure provides a communication system and method, among other things. As a non-limiting example, the method includes registering a first user device as a first Multi Device Access (MDA) device for a user, registering several other user devices as MDA devices for the user, marking the first user device with a first alerting priority, marking the other devices with a second alerting priority that is different from the first alerting priority, receiving an incoming call for the user, and causing the first user device to alert for the incoming call at a different time than the other user devices based on the first alerting priority being different from the second alerting priority.

### FIELD OF THE DISCLOSURE

Embodiments of the present disclosure relate generally to communications and, in particular, to dynamic designation of device priorities in a multiple device access configuration.

### BACKGROUND

Various communication systems have been configured to support multiple device access (MDA). Most systems rely on Session Initiation Protocol (SIP) parallel forking to handling device alerting for each device registered by the user. Specifically, in implementing MDA, some systems may allow a user to register a certain number of devices to an MDA group and each device is registered to the same extension to enable MDA features. Some users may have several registered devices within a common space (e.g., an office, a room, etc.) so when a call comes in for the user, all of the registered devices ring or implement their device-specific alerting behavior. Problematically, if the user wants to ignore such a call, the user may have to invoke an ignore or drop feature on each of their registered devices; otherwise, the registered device(s) will continue to alert until the call is answered or goes to voicemail.

### BRIEF SUMMARY

Embodiments of the disclosure solves these and other issues by providing a user with the ability to register multiple devices with the same extension, thereby enabling each registered device to provide MDA functions to the user, and by also providing the user with the ability to define and control how each device alerts and in what order of priority each registered device alerts.

One aspect of the present disclosure is to provide an MDA feature that supports the designation of one registered device as a primary device, with all other registered devices being designated as a secondary device. It may also be possible to register one or more devices as a primary device (e.g., with a primary priority), one or more other devices as a secondary device (e.g., with a secondary priority), one or more other devices as a tertiary device (e.g., with a tertiary priority), and so on. In other words, embodiments of the present disclosure are not limited to two priority levels, but rather may include two, three, four, or more priority levels assigned to one or multiple different devices.

Another aspect of the present disclosure is to provide static and/or dynamic mechanisms by which the user can register one device as primary as compared to other devices. Such mechanisms include: (a) a default registration where no device is primary; (b) dynamic registration where the user presses a button on a specific device to mark it as the primary device; (c) on-the-fly selection where the backend system providing the MDA feature automatically marks the device from which the user placed or answered the last call as the primary device (it should be noted that pressing a feature button can also serve this purpose); (d) presence-based selection where the backend system providing the MDA feature monitors a presence state of each registered device and marks the device from which the most recent “active” indication was received as the primary device (it should also be noted that mouse/keyboard usage on an agent PC can also update the user's presence status); and combinations thereof.

Another aspect of the present disclosure is to provide a bot or similar type of automated service that can monitor the same indications of presence at a registered device and build a historical schedule of which registered device might be primary. This historical information can be used to switch the primary device automatically if no indication of presence has been detected over a defined period of time (e.g., one day, one week, one month, etc.). Similarly, a bot or automated service may also be configured to identify which devices are mobile and which are stationary and prefer the mobile devices when stationary device presence has not been recently detected. In some embodiments, the automated service may be configured to send one, some, or all of the registered devices an understood request for status information and the registered device(s) may respond with their status, which can then be used by the automated service to assign priorities to the device(s). Continuing the above example, if one or more of the registered devices are mobile devices, then the automated service may utilize an Apple Push Notification service (APN) or Google Cloud Messaging (GCM), depending upon the operating system being used by the mobile device. In some embodiments, a REGISTER or SUBSCRIBE timeout and/or presence timer may be used by the automated service to determine presence at a device, but the respectively timeout periods associated with such mechanisms may also be taken into account by the automated service prior to automatically changing priorities of the registered devices.

Another aspect of the present disclosure is to enable a device marked as a primary device to be the only registered device that alerts (e.g., rings, vibrates, etc.) for a predetermined amount of time or a predetermined number of alerts. In other words, once a registered device has been marked primary, a new incoming call to the user of the registered device will ring on the primary device only for several seconds. If that call is unanswered after a predefined amount of time, the call then rings on all of the secondary devices as well. Further still, if the user presses an “Ignore” key on the primary device, the call stops ringing there and does not proceed to ring the secondary devices.

Another aspect of the present disclosure is to provide a mechanism for handling incoming high priority calls and emergency calls. In some embodiments, an incoming high priority call or emergency call may override one or more of the MDA features described herein and alert/ring all of the registered devices, irrespective of each device's defined priority.

One aspect of the present disclosure provides a system that includes:

a microprocessor;

memory coupled with the microprocessor and comprising instructions that are executable by the microprocessor, the instructions comprising:
instructions that register a first user device and a second user device with a common extension;
instructions that mark the first user device with a first alerting priority;
instructions that mark the second user device with a second alerting priority that is different from the first alerting priority; and
instructions that process an incoming call directed toward a user associated with the common extension based on the first alerting priority and the second alerting priority such that the first user device alerts at a different time than the second user device.

### BRIEF DESCRIPTION OF THE DRAWINGS

FIG. 1 is a block diagram illustrating components of a communication system according to embodiments of the present disclosure;

FIG. 2 is a block diagram illustrating components of a user device according to embodiments of the present disclosure;

FIG. 3 is a block diagram illustrating components of a server implementing an MDA feature according embodiments of the present disclosure;

FIG. 4 is a block diagram depicting a data structure used in connection with providing MDA features according to embodiments of the present disclosure;

FIG. 5 is a flow diagram depicting a method of configuring device registration for an MDA user according to embodiments of the present disclosure;

FIG. 6 is a flow diagram depicting a method of processing an incoming call directed toward an MDA user according to embodiments of the present disclosure;

FIG. 7 is a flow diagram depicting a method of monitoring user behavior and suggesting device registration priorities according to embodiments of the present disclosure; and

FIG. 8 is a flow diagram depicting a method of processing an incoming emergency call according to embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments of the disclosure provide the ability to configure multiple device access and then implement various telecommunication features based on the applied configurations. While embodiments of the present disclosure will be described in connection with a particular protocol for supporting multiple device access or MDA, it should be appreciated that embodiments of the present disclosure are not limited to MDA unless otherwise indicated. While the flowcharts will be discussed and illustrated in relation to a particular sequence of events, it should be appreciated that changes, additions, and omissions to this sequence can occur without materially affecting the operation of the disclosed embodiments, configuration, and aspects.

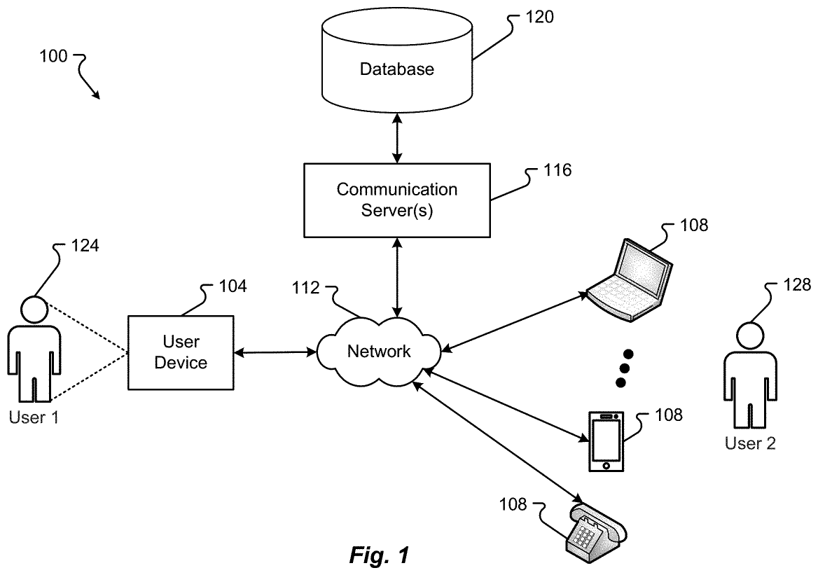

With reference now to FIG. 1, an illustrative communication system 100 will be described in accordance with at least some embodiments of the present disclosure. As shown in FIG. 1, the system 100 may include a plurality of user devices 104, 108. The various devices 104, 108 may communicate with one another via a communication network 112.

In one non-limiting embodiment, one or both devices 104, 108 may be similar in their capabilities. The difference between a user device 104 and user device 108 may simply be the type of user that utilizes the device. For instance, a first user 124 (which may also be referred to as a calling user) may be associated with a user device 104 whereas a second user 128 (which may also be referred to as a called user or MDA user) may be associated with one or more user devices 108. The user devices 108 associated with the second user 128 may each be registered with a common extension, thereby causing each user device 108 to be referred to as an MDA device, registered device, and/or registered MDA device. As depicted in FIG. 1, each user device 108 may be a different type of device (e.g., mobile device, telephone, personal computer, laptop, software application running on a personal computer or laptop, a tablet, etc.). It should be appreciated, however, that two or more user devices 108 may be of the same type without departing from the scope of the present disclosure. It should also be appreciated that the user device 104 may be similar or different from the types of user devices 108 associated with the second user 128. To be clear, the user devices 104, 108 may correspond to mobile communication devices (e.g., smartphones, tablets, wearable devices, laptops, Personal Digital Assistant (PDA), etc.) or communication devices that are not normally considered mobile (e.g., desk phone, personal computer, etc.).

The communication network 112 may include a cellular or other wireless network and the user devices 104 and/or 108 can include smartphones, tablets, laptop computers, wearable devices, or any other portable electronic device configured to communicate over the network 112. It should be understood that while only one user device 104 and three user devices 108 are illustrated here for the sake of simplicity, any number of devices of different types may be connected with the network 112 at any given time or may be in direct communication with one another at any given time. Moreover, the constitution of the types of devices connecting to the network 112 and to each other may also vary over time. Furthermore, the number of user devices 108 registered with a communication server 116 for purposes of providing the second user 128 with MDA features may be any number from two to N, where N corresponds to an integer value that is greater than or equal to two. It should further be appreciated that the maximum allowable number of devices that may register with the same extension may be programmatically defined. A non-limiting but illustrative maximum allowable number of registered devices may be ten devices, but it should be appreciated that the maximum allowable number of registered devices can be greater than or less than ten.

The network 112 can also include an Internet Protocol (IP) Multimedia Subsystem (IMS) framework providing Internet and/or other data services to the devices 104, 108 over the network 112. Generally speaking, the IMS framework of the network 112 can utilize Session Initiation Protocol (SIP) and/or other Internet Engineering Task Force (IETF) standard protocols to provide any number of IP multimedia services including but not limited to Voice over IP (VoIP) calling, media streaming, web access, etc. Alternatively or additionally, the network 112 may include a distributed computing network such as the Internet, an APN service, a GCM, or some other packet-based communication network.

The communication system 100 may further include one or more databases 120 that are managed and utilized by one or more communication servers 116. The communication server(s) 116, in some embodiments, may be configured to manage the communication capabilities for the first user 124 and/or second user 128. In some embodiments, the communication server(s) 116 may manage communication preferences for the second user 128 and may further manage MDA features that are provided to the second user 128 in accordance with MDA preferences and priorities set by the second user 128 with the communication server(s) 116. Although depicted as a single node, it should be appreciated that functions of the communication server(s) 116 may be provided by one or many different servers, each of which may be connected to the network 112 either directly or through another server. As will be discussed in further detail herein, the communication server(s) 116 may be configured to manage MDA features provided to the second user 128, manage device registration for multiple user devices 108 desired to implement MDA features for the second user 128, and perform other tasks in connection with managing alerting and communication session preferences defined by the second user 128. Although not depicted, it should be appreciated that one or more firewalls or Session Border Controllers (SBCs) may be provided between a user device 108 and the communication server 116, meaning that a user device 108 does not necessarily need to be on the same LAN as the communication server 116. Rather, one or more other networks administered by different entities may combine as part of the network 112 and may reside between the communication server 116 and a user device 108.

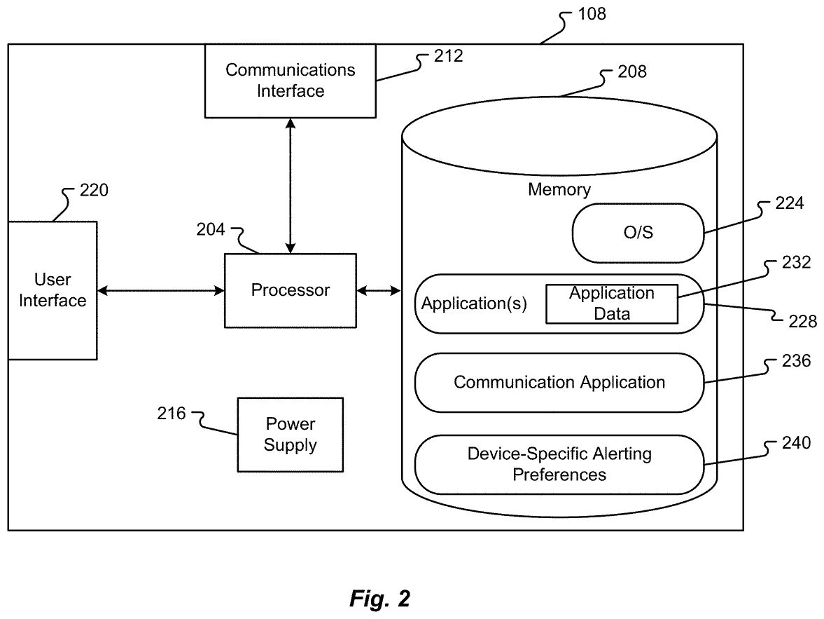

With reference now to FIG. 2, additional details of a user device 108 will be described in accordance with at least some embodiments of the present disclosure. Although the devices 108 are referred to generally as user device 108, it should be appreciated that any type of device depicted and described herein (e.g., user device 104) may have similar or identical components to the user device 108 depicted in FIG. 2. Moreover, the various user devices 104, 108 depicted and described herein may correspond to mobile communication devices, wearable communication devices, computers, laptops, tablets, PDAs, Point of Sale (PoS) terminals, etc.

The illustrative device 108 is shown to include a processor 204, memory 208, a communication interface 212, a power supply 216, and a user interface 220. In some embodiments, all of the components of device 108 are provided within a common device housing and are connected via a one or multiple circuit boards.

The processor 204 may correspond to one or multiple processing circuits. In some embodiments, the processor 204 may include a microprocessor, an Integrated Circuit (IC) chip, an ASIC, or the like. The processor 204 may be configured with a plurality of logic circuits or circuit elements that enable the processor 204 to execute one or more instructions or instruction sets maintained in memory 208. Alternatively or additionally, the processor 204 may be configured to execute instructions received via the communications interface 212. As another example, the processor 204 may be configured to execute one or more drivers that are specifically provided for the communications interface 212 and/or the user interface 220.

The memory 208 is shown to be in communication with the processor 204. The memory 208 may include any type or combination of computer memory devices. Non-limiting examples of memory 208 include flash memory, volatile memory, non-volatile memory, RAM, NVRAM, SRAM, ROM, EEPROM, etc. As can be appreciated, the types of devices used for memory 208 may depend upon the nature and type of data or instructions stored in memory 208.

In the depicted embodiment, the memory 208 includes an operating system (O/S) 224, one or a plurality of applications 228, a communication application 236, and device-specific alerting preferences 240. A user 128 of the device 108 may be enabled to access and utilize the applications 228 and/or messaging application 236 via use of the O/S 224. Examples of an O/S 224 include Apple iOS, Android OS, Blackberry OS, Windows OS, Mac OS, Palm OS, Open WebOS, etc. The O/S 224 may correspond to a mobile-specific operating system, PC-specific operating system, or any other type of known operating system. In some embodiments, the O/S 224 can be configured to provide a display of icons that are presented via the user interface 220. Some or all of the icons may be selectable by the user 128 of the user device 108 to access routines or features provided by applications 228, 236. In some embodiments, each application 228, 236 has a specific icon associated therewith that is presented via a home screen of the O/S 224. When that specific icon is selected by a user 128, the user interface 220 of the device 108 may present application-specific data and application-specific graphics 232.

Examples of applications 228 and their instructions sets 232 that may be maintained in memory 208 include calling applications, web browsing applications, social networking applications, gaming applications, camera applications, photo applications, video applications, messaging applications, word-processing applications, calendaring applications, contact management applications, and any other known type of application.

The communication application 236 may correspond to a particular type of application 228 that facilitates communications with other user devices across a network 112. The communication application 236, in some embodiments, may correspond to a voice-based communication application, a video-based communication application, a text-based communication application, or a multi-media communication application. In some embodiments, the communication application 236 may be configured to facilitate any number of communication modalities. In some embodiments, the capabilities of the communication application 236 may be provided by or built into the O/S 224. In some embodiments, the communication application 236 may correspond to a separate set of instructions that are called by the O/S 224.

The communication application 236, in some embodiments, may reference and utilize the device-specific alerting preferences 240 to control a manner in which the user device 108 alerts when an incoming call is received at the communications interface 212. A user 128 of the user device 108 may be allowed to define, adjust, or control the device-specific alerting preferences 240 for a particular user device 108. For instance, a user 128 may be allowed to define device-specific alerting preferences that cause the user device 108 to ring, flash a light, vibrate a haptic feedback mechanism, or combinations thereof when an incoming call is received at the user device 108. In other words, if one or more messages are received at the communications interface 212 indicating that an incoming call has been received, the communication application 236 may refer to the device-specific alerting preferences 240 to cause other hardware components of the user device 108 to activate and alert the user 128 that an incoming call request has been received. It should be appreciated that if the user 128 has multiple user devices 108 registered with their MDA profile (e.g., registered with a common extension), then each user device 108 may alert according to its own device-specific alerting preferences 240 unless the incoming call message indicates that a particular type of alerting should be utilized (e.g., in the case of an incoming emergency call or incoming emergency alert that overrides the device-specific alerting preferences 240).

The communications interface 212 provides hardware and drivers that enable the device 108 to connect with the network 112, receive communications from the network 112, and/or provide communications to the network 112 for delivery to another user device. The communications interface 212 may also include functionality that facilitates device-to-device connectivity (e.g., Bluetooth, Bluetooth Low Energy (BLE), NFC, etc.) connections. It should be appreciated that the communications interface 212 may include one or multiple different interfaces that facilitate different kinds of wireless and/or wired connectivity. In some embodiments, the communications interface 212 includes a wired and/or wireless network adapter. Non-limiting examples of a communications interface 212 include an antenna and associated driver (e.g., a WiFi or 802.11N antenna and/or driver), an Ethernet card and/or driver, a serial data port (e.g., a USB port) and/or driver, a Bluetooth or BLE antenna and/or driver, an NFC antenna and/or driver, or any other type of device that facilitates inter-device communications. The communications interface 212 may receive one or more data packets or messages from the communication network 112 and extract data therefrom. The data extracted from the received data packets or messages may be provided to the processor 204 where the data can subsequently be processed using instructions stored in memory 208. Similarly, a Bluetooth or BLE interface may enable the exchange of information with another device 108, but such exchanges may not necessarily require the exchange of data packets.

The power supply 216 may correspond to an internal power source and/or adapter for connection with an external power source. In the example of an internal power source, the power supply 216 may correspond to a battery or cell of batteries used to power the various other components of the user device 108. Alternatively or additionally, the power supply 216 may include a power converter or power conditioner that enables power received from an external source (e.g., a 120V AC power source) to be converted into useable DC power that can be supplied to the various components of the user device 108.

The user interface 220 may correspond to a user input device, a user output device, a combination user input/output device, or a number of such devices. As an example of a user input device, the user interface 220 may include a microphone, a button, a physical switch, a camera, an accelerometer, or the like. As an example of a user output device, the user interface 220 may include a speaker, a light, a display screen, a tactile output device (e.g., a haptic feedback device), or the like. As an example of a combination user input/output device, the user interface 220 may include a touch-sensitive display screen that has one or more areas thereof capable of presenting a Graphical User Interface (GUI) element and, if touched or selected by a user, recognizing that the GUI element has been selected by the user.

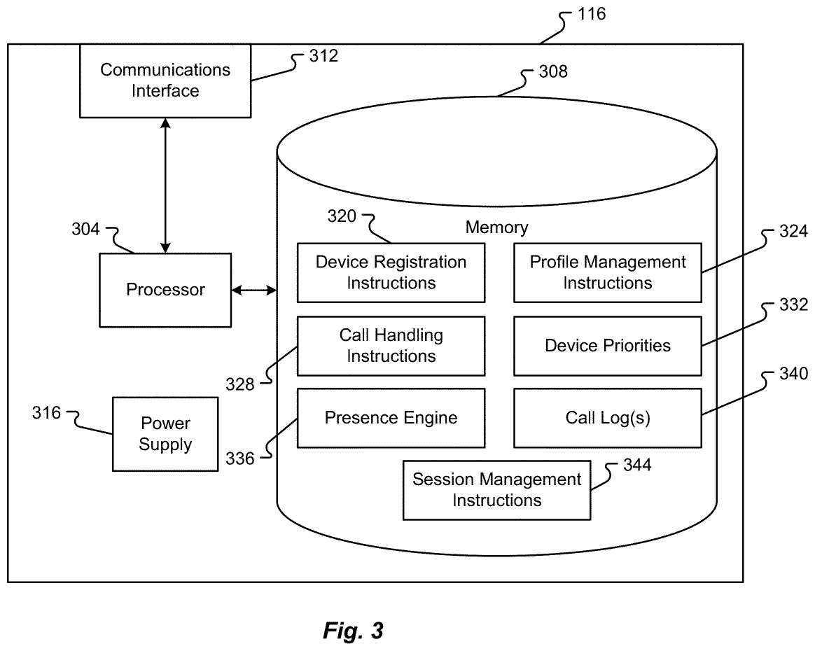

With reference now to FIG. 3, details of a communication server 116 will be described in accordance with at least some embodiments of the present disclosure. The communication server 116 may be executed by a single server, a plurality or servers, one or more virtual machines operating on a server, a server cluster, or the like. A communication server 116 may, in some embodiments, have several components similar to a user device 108 except that the communication server 116 generally does not provide a rich user interface. Rather, the communication server 116 is shown to include a processor 304, memory 308, a communications interface 312, and a power supply 316. Although certain elements are shown as being provided in memory 308 and not memory 208, it should be appreciated that some or all of the components depicted in FIG. 3 may be provided in a user device 108. Likewise, some or all of the components depicted in FIG. 2 may be provided in a communication server 116 without departing from the scope of the present disclosure.

In some embodiments, the processor 304 may be similar or identical to processor 204. As an example, the processor 304 may include one or more of a microprocessor, an IC chip, an ASIC, or combinations thereof. Likewise, the memory 308 may be similar or identical to memory 208. As an example, the memory 308 may include one or more computer memory devices that may be volatile or non-volatile in nature. The power supply 316 may be similar or identical to power supply 216. As an example, the power supply 316 may correspond to a power converter that is capable of converting AC input power into DC power that is useable by the various components of the server(s) providing the service 116.

Memory 308 is further shown to include instructions that enable the communication server 116 to provide MDA functions and features to users 128 having multiple user devices 108 registered against their MDA profile (e.g., associated with a common extension). As discussed above, some or all of the instructions stored in memory 308 may be executable by the processor 304 in connection with providing the services described herein.

As some non-limiting examples, the memory 308 may include device registration instructions 320, profile management instructions 324, call handling instructions 328, device priorities 332, a presence engine 336, one or more call logs 340, and session management instructions 344. These various instructions, preferences, logs, or rules may be provided within a single application stored in memory 308 or they may be separated as shown. Similarly, one or more instructions or data structures may be stored in the database 120 rather than being provided in memory 308 of the communication server 116.

The device registration instructions 320, when executed by the processor 308, may enable the communication server 116 to facilitate device registration and update device priorities 332 based on preferences defined by a user 128 during a device registration process. In some embodiments, the device registration instructions 320 may present one or more GUI elements or an API to a user device 108, thereby enabling the user 128 of the user device 108 to register one or more user devices with a common extension. The device registration instructions 320 may also be configured to determine if a maximum number of devices have already been registered with a common extension and, if such a determination is made, provide the user 128 with an option of deleting a previously-registered device or discontinuing further registration of the newest device.

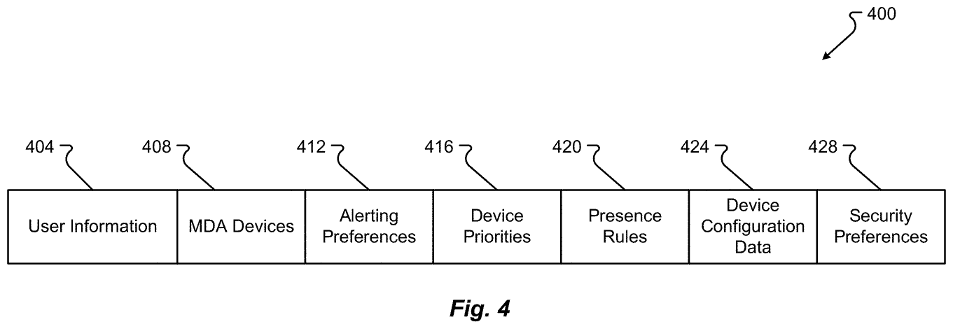

The profile management instructions 324 may be configured to manage an MDA profile of a user 128 and update device priorities 332 based on configurations of the user's 128 MDA profile. As will be discussed in further detail herein with reference to FIG. 4, a user's 128 MDA profile may be stored as one or more data structures within memory 308 or within a database 120. As additional devices are registered against a user's 128 profile (e.g., registered with a common extension), the profile management instructions 324 may update the MDA profile for that user 128 and update device priorities defined within the user's 128 MDA profile. The profile management instructions 324 may also be configured to provide each registered MDA device 108 with configuration data upon login. For instance, the profile management instructions 324 may download the same button data to each registered MDA device, download location-specific data to each registered MDA device based on the location of that device, and/or provide device settings on a per-device basis.

It should be appreciated that the device registration instructions 320 and/or profile management instructions 324 may further include Artificial Intelligence (AI) capabilities which enable the communication server 116 to monitor user 128 behavior with their various user devices 108 and take various automated or semi-automated actions based on the monitoring of the user's 128 behavior. For instance, the profile management instructions 324 may be configured to monitor a user's 128 behavior when a call is received from a particular calling user and if the user 128 answers such calls more often than not on a particular user device 108 as compared to other user devices 108, the profile management instructions 324 may suggest to the user 128 that the particular user device 108 be set as a primary or first priority device within the device priorities 332. The suggestion of such a priority setting may be proposed for all calls directed to the user 128, for all calls directed to the common extension, for only calls directed to the user 128 by the particular calling user, or for only calls directed to the common extension by the particular calling user. As another example, the AI capabilities of the profile management instructions 324 may determine a last user device 108 that was engaged by the user 108 and the profile management instructions 324 may automatically or semi-automatically (e.g., based on approval by the user 128) define the last-engaged user device 108 as the primary registered user device 108 whereas all other registered devices are re-prioritized to a secondary or lower priority designation.

The observations made by the profile management instructions 324 and/or device registration instructions 320 may alternatively or additionally be made with reference to a call log 340 for the various registered devices associated with a user 128. The call log(s) 340 may include device-specific call logs, user 128 specific call logs, extension-specific call logs, or combinations thereof. In some embodiments, a call log may not be synchronized between registered user devices 108 unless the user 128 is configured for centralized call logging and uses device types that support a centralized call log feature. If centralized call logging is enabled, then the call logs of each registered user device 108 may be synchronized at login time. Although not depicted, each user device 108 may maintain its own call log; therefore, if a call toward an MDA user is answered at one registered user device 108 but not other registered user devices 108, then the call would appear as “Answered” on the call log of the registered user device 108 where answered, but the call would appear as “Missed” on the call log(s) of other registered user devices 108 (at least until such time as the call logs are re-synchronized by a centralized call logging feature). It should also be appreciated that an outbound call made by one registered user device 108 that is not answered would not be logged by other registered user devices 108 (at least until such time as the call logs are re-synchronized by a centralized call logging feature).

The presence engine 336, when executed by the processor 304, may enable the communication server 116 to determine presence information for a user 128. Such presence information may be determined with respect to activity at a particular user device 108 and/or based on other mechanisms for determining user presence (e.g., based on whether the user 128 has logged into the system, etc.). In some embodiments, each registered user device 108 may simultaneously subscribe for presence services offered by the presence engine 336. The registered user devices 108 may publish presence state to the presence engine 336, thereby enabling the presence engine 336 to aggregate the presence state for the user 128 across the user's 128 multiple registered user devices 108. The device registration instructions 320 and/or profile management instructions 324 may be configured to retrieve or request presence information from the presence engine 336 in connection with providing various registration and/or profile management instructions 324.

The call handling instructions 328, when executed by the processor 304, may enable the communication server 116 to process incoming calls based on device priorities 332 defined by/for the MDA user 128. The call handling instructions 328 may also be configured to request presence information from the presence engine 336 thereby enabling presence-based alerting to be provided to the user 128, possibly also in alignment with alerting preferences that refer to the device priorities 332. In some embodiments, the call handling instructions 328 may be configured to alert registered user devices 108 according to the device priorities 332 such that less than all of the registered user devices 108 alert for an incoming call at the same time and/or in the same way. For example, the call handling instructions 328 may be configured to cause a first registered user device 108 (e.g., a user device 108 identified as a primary user device 108 in the device priorities 332) to alert before other registered user devices 108 (e.g., user devices identified as secondary or non-primary user devices in the device priorities 332). The call handling instructions 328 may cause a user device 108 to alert by sending a call notification message or incoming call message (e.g., a SIP INVITE message) to the user device 108, which in turn causes the user device 108 to alert according to device-specific alerting preferences 240. Alternatively, the device-specific alerting preferences 240 of the user device 108 may be overridden if the incoming call message defines an override condition (e.g., the incoming call is a high priority or emergency call).

The session management instructions 344, when executed by the processor 304, may enable the communication server 116 to manage various aspects of a communication session between a called user 128 and calling user. The session management instructions 344, in some embodiments, may invoke other sequenced applications to provide call functions to the user 128 in accordance with user 128 preferences. For instance, the session management instructions 344 may be configured to manage conference features, transfer features, hold features, security features, call forwarding features, call admission control features, and the like. In some embodiments, the session management instructions may be configured to manage various call admission control limits and counts based on locations of registered user devices 108 and/or based on which user device 108 is used to accept an incoming call for the user 128.

With reference now to FIG. 4, additional details of a data structure 400 used to maintain an MDA profile for an MDA user 128 will be described in accordance with at least some embodiments of the present disclosure. The data structure 400 may be stored in a single data storage location (e.g., a centralized database like a centralized database 120, within memory 308 of a communication server 116, etc.) or among a plurality of storage media (e.g., as a distributed ledger, among a Distributed Storage Network (DSN), among a plurality of communication servers 116, etc.).

Examples of the data fields that may be provided in data structure 400 include, without limitation, a user information field 404, an MDA devices field 408, an alerting preferences field 412, a device priority field 416, a presence rules field 420, a device configuration data field 424, and a security preferences field 428. The user information field 404 may be used to store information that describes the user 128 for which the MDA profile is being used. For instance, the user information field 404 may be used to store a username, an account number assigned to the user 128, addressing or alias information for the user (e.g., SIP address, email address, IM address, etc.), and the like.

The MDA devices field 408 may be used to store information that describes each user device 108 that is registered with the common extension for the MDA user 128. For instance, the MDA devices field 408 may store IP addresses of each registered MDA device 108, MAC addresses of each registered MDA device 108, a device name assigned to each registered MDA device 108, a device type for each registered MDA device 108, and any other information that describes or differentiates one registered MDA device 108 from another registered MDA device 108.

The alerting preferences field 412 may be used to store information that describes alerting preferences defined by an MDA user 128. Such preferences may be globally applied to all registered MDA devices 108 or the preferences may be device specific. In some embodiments, the alerting preferences 412 may describe a type of alerting to invoke on some or all registered MDA devices 108 when a particular incoming call is received for the MDA user 128. For instance, the alerting preferences 412 may define one alerting type for incoming voice calls, a different alerting type for incoming video calls, yet another alerting type for incoming chats, etc. As used herein, an alerting type may define one or more of a ring pattern, a ring tone, a ring volume, a ring loudness, a light brightness, a frequency of light flashing, a color of light, a graphic to be presented, or combinations thereof.

The device priorities field 416, as compared to the alerting preferences field 412, may define a device priority for some or all of the registered MDA devices 108. In some embodiments, the device priorities field 416 may contain information similar to that described in connection with the device priorities 332. As such, the device priorities field 416 may contain information describing one or more registered MDA devices 108 as a primary device whereas other registered MDA devices 108 are identified as non-primary, secondary, tertiary, etc. In some embodiments, a registered MDA device 108 identified as primary in the device priorities field 416 may be the first registered MDA device 108 to receive an incoming call message or notification, thereby causing that primary device to alert (either according to alerting preferences 412 or device-specific alerting preferences 240) before other non-primary devices begin to alert. Only after a predetermined amount of time will the next or non-primary devices begin to alert, possibly based on further defined alerting priorities.

The presence rules field 420 may be used to store information that describes the manner in which a user's 128 presence should be considered in connection with applying call handling instructions 328 and other call features. For instance, the presence rules 420 may indicate a particular device priority if one type of user 128 presence is detected whereas a different device priority is applied if a different type of user 128 presence is detected. Presence rules described within the presence rules field 420 may be location-specific (e.g., based on a location of the user 128 or user device 108) or activity-specific (e.g., based on an action detected in connection with a user 128 or user device 108).

The device configuration data field 424 may be used to store various device configurations that can be applied to each registered MDA device 108. In some embodiments, the device configuration data 424 may be location-specific and may include button configurations, call features, call forwarding rules, etc.

The security preference field 428 may be used to store information or rules to be applied when a user 128 receives or initiates a call that requires a higher level of security than a normal call. For instance, the security preferences field 428 may define rules that cause only certain registered MDA devices be alerted when an incoming call is identified as a secure call. Such registered MDA devices may correspond to those devices with the appropriate hardware and/or software that facilitates the security required for the call (e.g., encryption capabilities, devices registered using TLS transport, etc.). Continuing this example, any user device 108 that is registered using non-TLS (e.g., TCP or UDP) transport may not be alerted when a secure call comes in for the MDA user 128. However, the associated call appearance may still indicate the presence of the call on all devices. The security preferences 428 may also define that a bridge-on attempt from a non-TLS registered MDA device 108 to a secure call be denied.

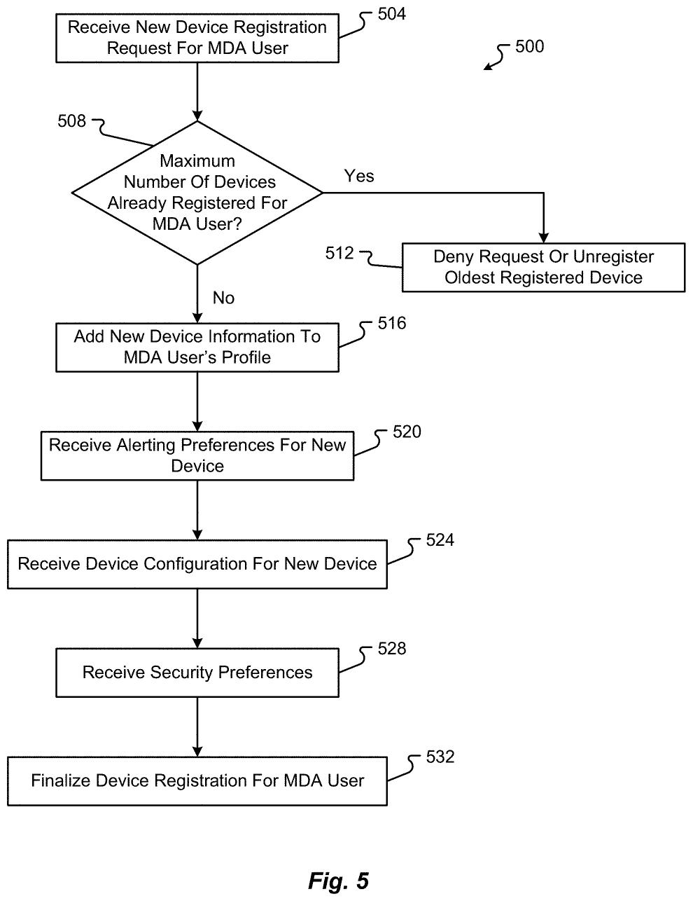

With reference now to FIGS. 5-8, various methods of operating a communication system 100 and providing MDA features to a user 128 will be described in accordance with at least some embodiments of the present disclosure. While certain steps are described in connection with a particular method, it should be appreciated that any method may include or not include those steps depicted in connection therewith. Likewise, certain steps depicted in connection with one method may be implemented in another method without departing from the scope of the present disclosure.

Referring initially to FIG. 5, a method 500 of configuring device registration for an MDA user 128 will be described according to embodiments of the present disclosure. The method 500 begins when a request is received to register a new device for an MDA user 128 (step 504). The request may be received at the communication server 116 and may be processed by the device registration instructions 320. Upon receiving the request, the device registration instructions 320 may determine whether a maximum number of devices are already registered for the MDA user 128 that submitted the newly received device registration request (step 508). The maximum number of registered devices may be limited based on preferences defined by the MDA user 128 and/or based on policies enforced by an administrator of the communication system 100. The maximum number of registered devices may be adjusted from time-to-time, if desired. As discussed herein, registered devices may each be registered with a common extension, thereby qualifying each registered device to provide MDA features to the MDA user 128.

If the query of step 508 is answered positively, then the device registration instructions 320 may either deny the request, unregister the oldest registered device, or provide a response back to the MDA user 128 indicating that the maximum number of devices have already been registered (step 512). If a response is provided back to the MDA user 128, the response may further suggest possible steps to take to solve the issue (e.g., a suggestion to unregister a device or discontinue the current registration request).

If the query of step 508 is answered negatively, then the device registration instructions 320 continue by determining new device information from the device being registered and adding such new device information to the MDA user's 128 MDA profile (step 516). In some embodiments, this step may involve updating the MDA profile 400 and, in particular, the MDA devices field 408 with pertinent information retrieved from the device being registered.

The method 500 may continue with the device registration instructions 320 receiving alerting preferences for the new device (step 520). The alerting preferences may be received from or defined by the MDA user 128. In some embodiments, if the MDA user 128 does not provide alerting preferences, then default preferences may be applied. In some embodiments, the MDA user 128 may define alerting preferences by indicating the new device should be assigned a particular alerting priority (e.g., a primary priority, a secondary priority, a tertiary priority, etc.). The priority assigned to the device (e.g., as alerting preferences) may be updated in the alerting preferences field 412 by the profile management instructions 324.

The method 500 may further continue with the device registration instructions 320 receiving device configuration data for the new device (step 524). The new device configuration data may be provided to the profile management instructions 324, which updates the device configuration data field 424.

The method 500 may further include receiving security preferences or the like for the new device (step 528). Again, this information may initially be received at the device registration instructions 320, which passes the information to the profile management instructions 324 for updating the security preferences field 428. The method 500 may then conclude when all appropriate data fields associated with the new device have been updated in the MDA profile 400. When the device registration instructions 320 determines that no additional data is needed to update the MDA profile, the device registration method 500 may conclude for the MDA user 128 (step 532).

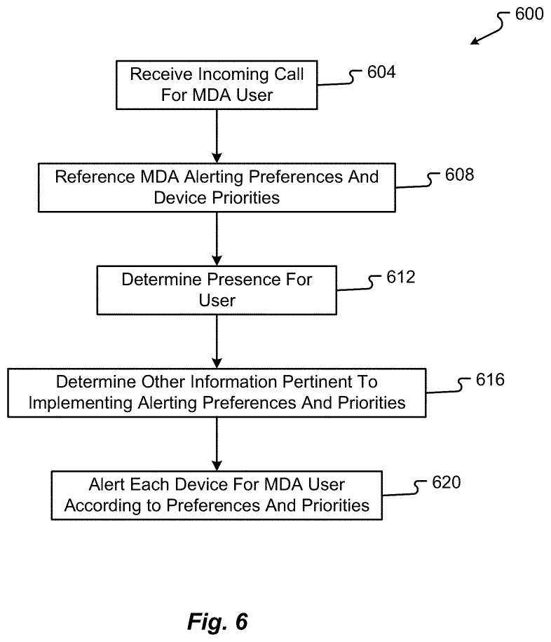

Referring now to FIG. 6, a method 600 of processing an incoming call directed toward an MDA user 128 will be described according to embodiments of the present disclosure. The method 600 begins when an incoming call (or incoming call notification) is received for an MDA user 128 (step 604). In some embodiments, the incoming call or call notification may be received at the communication server 116 and may be processed by the call handling instructions 328. The incoming call may correspond to a voice, video, multimedia, or other type of call and may be directed toward a common extension with which multiple user devices 108 of the MDA user 128 have been registered. Alternatively or additionally, the call may be directed toward an address or alias associated with the MDA user 128 (e.g., a SIP address, an IP address, a username, etc.).

Regardless of how the incoming call or call notification is received, the call handling instructions 328 will eventually determine that the call is directed toward a user 128 having MDA features provided thereto. In other words, the called user 128 may have multiple MDA user devices 108 registered to provide MDA functions to the user 128. The call handling instructions 328 will then reference the MDA profile 400 of the MDA user 128 to determine alerting preferences and/or device priorities to apply when alerting some or all of the registered MDA user devices 108 (step 608). If the alerting preferences and/or priorities define that alerting should be provided in accordance with a presence of the user 128, then the call handling instructions 328 may optionally obtain current presence information for the user 128 from the presence engine 336 (step 612). The call handling instructions 328 may further determine if any other information is pertinent to implementing the alerting preferences and/or priorities (step 616). As a non-limiting example, the call handling instructions 328 may determine which registered MDA user devices 108 was last (or most recently used) by the user 128 to dynamically assign that particular registered MDA user device 108 the primary priority for the current incoming call.

Based on the information obtained by the call handling instructions 328, the method 600 may then continue with the communication server 116 causing one, some, or all of the registered MDA user devices 108 to alert according to the determined preferences and/or priorities (step 620). The various registered MDA user devices 108 may be caused to alert by transmitting an incoming call message to the registered MDA user devices 108 (either simultaneously or in an order determined based on the preferences/priorities). In accordance with traditional MDA features, when the call is answered at one of the registered MDA user devices 108, the other devices that were concurrently alerting may discontinue alerting and register their version of the incoming call as a “Missed Call” unless and until such time as the registered MDA user devices 108 reconcile their independent call logs with one another at a centralized call log 340.

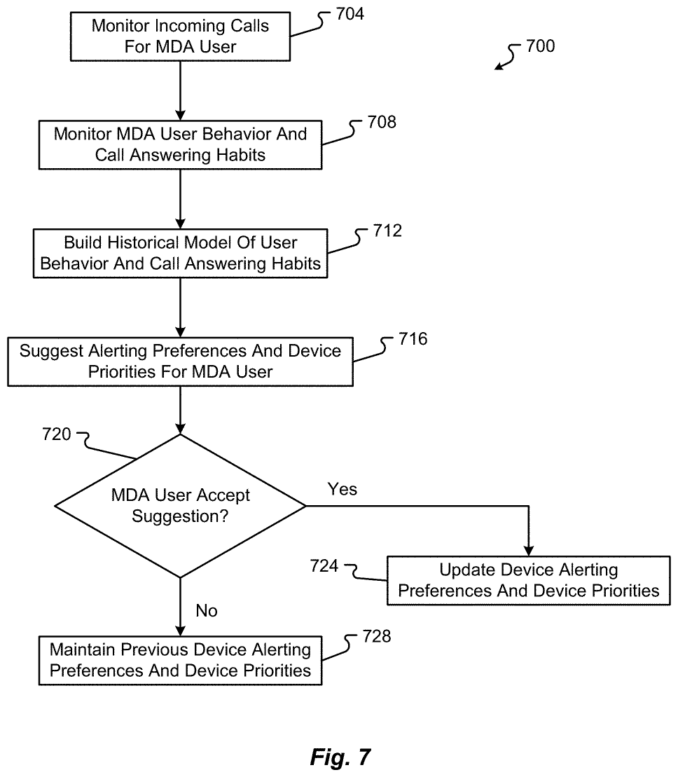

Referring now to FIG. 7, a method 700 of monitoring user behavior and suggesting device registration priorities will be described according to embodiments of the present disclosure. As discussed above, the method 700 may be performed by a combination of the device registration instructions 320 and profile management instructions 324 implementing AI behaviors in which automated processes are implemented until user intervention is desired. The method 700 may begin by monitoring incoming calls for an MDA user 128 (step 704). The calls may be monitored over a period of time (e.g., a day, a week, a month, a year, etc.) and may be monitored in real-time or with reference to historical call data (e.g., a call log 340).

The method 700 may further include monitoring the MDA user's 128 behavior and call answering habits (step 708). In particular, the method 700 may include determining and building one or more historical models that describe the MDA user's 128 call answering habits (e.g., when calls are answered, when calls are answered at a particular registered device, when calls are ignored at a particular device known to be in the presence of the user 128, when calls are dropped at a particular device, when calls are answered at a device identified as a primary device, when calls are answered at a device identified as a secondary device, ratios of calls answered at secondary device as compared to a primary device, etc.). The historical models may be built into any type of data model capable of being processed by a neural network or the like.

The method 700 may then continue by providing or suggesting alerting preferences and/or device priorities for the MDA user 128 that are different from the currently configured alerting preferences and/or device priorities (step 716). A suggestion for a different alerting preference and/or device priority may be provided in response to determining that the historical model substantially deviates or is different from the currently defined alerting preferences and/or device priorities. Said another way, if the user behavior is determined to substantially align (e.g., within a defined deviation) with the user's 128 current alerting preferences and/or device priorities, then there is no need to suggest a different alerting preference and/or device priority.

If, however, there is a deviation between the observed user behavior (e.g., as described in the historical model built in step 712) and the user's 128 current alerting preferences and/or device priorities, then the method 700 may continue by suggesting the alternative alerting preference and/or device priority. The method 700 may, in some embodiments, implement the alternative alerting preference and/or device priority automatically and without asking permission from the user 128. In other embodiments, the method 700 may continue by providing the user 128 with the suggestion and then waiting to see if the user 128 accepts or denies the suggestion (step 720). If the suggestion is accepted, then the method 700 will continue by invoking the profile management instructions 324 to update the device alerting preferences field 412 and/or device priority field 416 in the user's 128 MDA profile (step 724). On the other hand, if the query of step 720 is answered negatively, then the method 700 may maintain the current/previous device alerting preferences and/or device priorities (step 728).

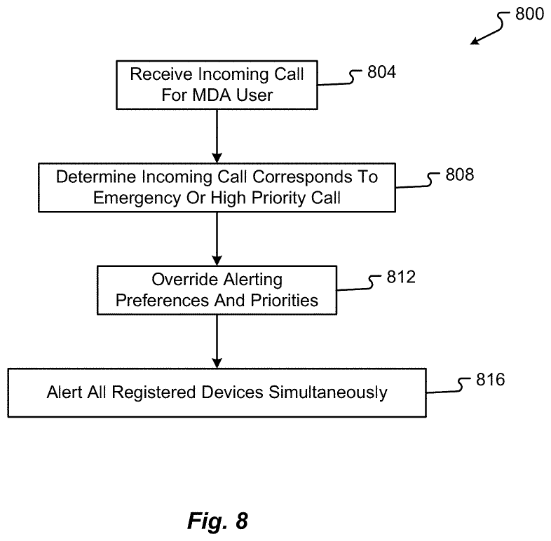

Referring now to FIG. 8, a method 800 of processing an incoming emergency call will be described according to embodiments of the present disclosure. The method 800 begins when an incoming call is received for an MDA user 128 (step 804). The method 800 continues when the call handling instructions 328 determines that the incoming call corresponds to an emergency call or a call requiring a higher level of security than a normal incoming call (step 808). Upon determining that the incoming call should be handled differently from a normal incoming call (e.g., by virtue of the call being an emergency call or a secure call), the method 800 continues with the call handling instructions 328 overriding the standard alerting preferences and priorities (step 812) and alerting the registered MDA user devices 108 according to a different protocol than defined by the MDA profile 400 (step 816). In some embodiments, the call handling instructions 328 may cause all registered MDA user devices 108 to alert substantially simultaneously even though one or more of the devices is identified as a primary priority device and other devices are identified as a secondary priority device (e.g., in the case of an incoming emergency call). Alternatively, the call handling instructions 328 may cause less than all registered MDA user devices 108 to alert if only some of the registered MDA user devices 108 are capable of supporting the security requirements of the incoming call (e.g., in the case of an incoming secure call).

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system, comprising:
a microprocessor;
memory coupled with the microprocessor and comprising instructions that are executable by the microprocessor, the instructions comprising:
instructions that register a first user device and a second user device with a common extension;
instructions that mark the first user device with a first alerting priority;
instructions that mark the second user device with a second alerting priority that is different from the first alerting priority; and
instructions that process an incoming call directed toward a user associated with the common extension based on the first alerting priority and the second alerting priority such that the first user device alerts at a different time than the second user device.

2. The system of claim 1, wherein the incoming call directed toward the user associated with the common extension will simultaneously alert both the first user device and the second user device in an absence of the first user device being marked with the first alerting priority and the second user device being marked with the second alerting priority that is different from the first alerting priority.

3. The system of claim 1, wherein the first alerting priority is higher than the second alerting priority and wherein the first user device alerts a predetermined amount of time prior to the second user device.

4. The system of claim 3, wherein the instructions further comprise:
instructions that determine the incoming call is answered at the first user device;
instructions that update a call log associated with the first user device to indicate that the call was answered at the first user device; and
instructions that update a call log associated with the second user device to indicate that the call was missed at the second user device.

5. The system of claim 4, further comprising a centralized call log and wherein the instructions further comprise:
instructions that update the centralized call log based on the call log associated with the first user device and the call log associated with the second user device, wherein the centralized call log is updated to indicate that the incoming call was answered at the first user device.

6. The system of claim 1, wherein the instructions further comprise:
instructions that register a third user device with the common extension; and
instructions that mark the third user device with the second alerting priority or a third alerting priority, wherein the third user device alerts at substantially the same time as the second user device when marked with a second alerting priority or alerts at a different time from the second user device when marked with a third alerting priority.

7. The system of claim 1, wherein the first user device comprises a wireless communication interface and wherein the second user device comprises a wired communication interface.

8. The system of claim 1, wherein the instructions further comprise:
instructions that monitor an answering behavior of the user over a period of time;
instructions that determine the answering behavior of the user over the period of time deviates from an anticipated answering behavior that is based on the first user device being marked with the first alerting priority and the second user device being marked with the second alerting priority; and
instructions that suggest an alternative device priority based on determining that the answering behavior of the user over the period of time devices from the anticipated answering behavior.

9. The system of claim 1, wherein the instructions further comprise:
instructions that determine the incoming call comprises an emergency call; and
instructions that alert the first user device and the second user device for the emergency call substantially simultaneously even though the first alerting priority is different from the second alerting priority.

10. A computer memory device comprising instructions stored therein which, when executed by a processor, enable the processor to:
register a first user device and a second user device with a common extension;
mark the first user device with a first alerting priority;
mark the second user device with a second alerting priority that is different from the first alerting priority;
receive an incoming call for the common extension; and
cause the first user device to alert for the incoming call at a different time than the second user device based on the first alerting priority being different from the second alerting priority.

11. The computer memory device of claim 10, wherein the first alerting priority is higher than the second alerting priority and wherein the first user device alerts a predetermined amount of time prior to the second user device.

12. The computer memory device of claim 10, wherein the instructions further enable the processor to:
determine the incoming call is answered at the first user device;
update a call log associated with the first user device to indicate that the call was answered at the first user device; and
update a call log associated with the second user device to indicate that the call was missed at the second user device.

13. The computer memory device of claim 10, wherein the instructions further enable the processor to:
monitor an answering behavior of the user over a period of time;
determine the answering behavior of the user over the period of time deviates from an anticipated answering behavior that is based on the first user device being marked with the first alerting priority and the second user device being marked with the second alerting priority; and
automatically change the alerting priority of the first user device and the second user device based on determining that the answering behavior of the user over the period of time devices from the anticipated answering behavior.

14. The computer memory device of claim 10, wherein the instructions further enable the processor to:
determine the incoming call comprises an emergency call; and
alert the first user device and the second user device for the emergency call substantially simultaneously even though the first alerting priority is different from the second alerting priority.

15. A method, comprising:
registering a first user device as a first Multi Device Access (MDA) device for a user;
registering a second user device as a second MDA device for the user;
marking the first user device with a first alerting priority;
marking the second user device with a second alerting priority that is different from the first alerting priority;
receiving an incoming call for the user; and
causing the first user device to alert for the incoming call at a different time than the second user device based on the first alerting priority being different from the second alerting priority.

16. The method of claim 15, wherein registering the first user device and the second user device comprises registering both the first user device and the second user device with a common extension.

17. The method of claim 15, further comprising:
determining the incoming call is answered at the first user device;
updating a call log associated with the first user device to indicate that the call was answered at the first user device; and
updating a call log associated with the second user device to indicate that the call was missed at the second user device.

18. The method of claim 15, further comprising:
monitoring an answering behavior of the user over a period of time;
determining the answering behavior of the user over the period of time deviates from an anticipated answering behavior that is based on the first user device being marked with the first alerting priority and the second user device being marked with the second alerting priority; and
automatically changing the alerting priority of the first user device and the second user device based on determining that the answering behavior of the user over the period of time devices from the anticipated answering behavior.

19. The method of claim 15, further comprising:
determining the incoming call comprises an emergency call; and
alerting the first user device and the second user device for the emergency call substantially simultaneously even though the first alerting priority is different from the second alerting priority.

20. The method of claim 15, further comprising:
determining that the user utilized the second user device more recently than the first user device; and
automatically marking the second user device with the first alerting priority based on determining that the user utilized the second user device more recently than the first user device.
